(19) United States
(12) Patent Application Publication
(10) Pub. No.: US 2023/0095612 A1
(43) Pub. Date: Mar. 30, 2023

(54) PROCESS FOR EXTRACTION OF LITHIUM

(71) Applicants: THE PENN STATE RESEARCH FOUNDATION, University Park, PA (US); NORTH CAROLINA STATE UNIVERSITY, Raleigh, NC (US)

(72) Inventors: Mohammad REZAEE, University Park, PA (US); Behzad VAZIRI HASSAS, University Park, PA (US); Hamid AKBARI, University Park, PA (US); Dinesh AGRAWAL, University Park, PA (US); Tania SLAWECKI, University Park, PA (US)

(21) Appl. No.: 17/801,059

(22) PCT Filed: Feb. 19, 2021
(86) PCT No.: PCT/US2021/018727

§ 371 Date: Aug. 19, 2022

Related U.S. Application Data
(60) Provisional application No. 62/978,992, filed on Feb. 20, 2020.

(51) Int. Cl. C01D 15/08; C22B 26/12; C22B 21/04; C22B 1/02; C22B 3/08

(52) U.S. Cl. CPC C01D 15/08; C22B 26/12; C22B 21/04; C22B 1/02; C22B 3/08

(57) ABSTRACT

Disclosed herein are methods for the recovery of lithium from lithium-bearing materials. More specifically, disclosed herein are methods comprising heating the lithium-bearing material with a solid roasting agent, forming a water suspension to allow to leach at least a portion of lithium into the water, separating a liquid and solid phase, and then exposing the collected solid phase to acid to allow acid leaching of the remaining amount of lithium.

### CROSS-REFERENCE TO RELATED APPLICATIONS

This application claims the benefit of U.S. Provisional Application No. 62/978,992, filed Feb. 20, 2020, the content of which is incorporated herein by reference in its entirety.

### BACKGROUND

Lithium is one of the critical elements with widespread applications in next-generation technologies, including energy storage, electric mobility and cordless devices (Meshram, P., Pandey, B. D., & Mankhand, T. R. (2014). “Extraction of lithium from primary and secondary sources by pre-treatment, leaching and separation: A comprehensive review. Hydrometallurgy,” 150, 192-208.; Martin, G., Rentsch, L., Hoeck, M., & Bertau, M. (2017). “Lithium market research—global supply, future demand and price development.” Energy Storage Materials, 6, 171479.). Due to its unique applications, lithium cannot be substituted in most applications; therefore, a steady increase of 8-11% in annual demand is anticipated (Baylis, R., 2013, January. “Evaluating and forecasting the lithium market from a value perspective.” In Roskill presentation, 5 the Lithium Supply and Markets Conference, Las Vegas (pp. 29-31); ENTR, E. (2014). “Report on Critical Raw Materials for the EU. Ares” (2015), 1819503). Meeting such a rising demand for lithium requires prospecting and processing all viable resources.

Two primary sources of lithium are ores (e.g., spodumene mineral) and brine sources. Li-rich clay sources are considered secondary sources. Additional Li-sources can comprise disposed Li-batteries and other recycled products.

As shown in the generic flowsheet demonstrated in FIG. 1, lithium is extracted from ores/minerals through mineral processing and then roasting, followed by leaching, while its extraction from brines includes evaporation, precipitation, adsorption and ion exchange (Garrett, D. E. (2004) Handbook of lithium and natural calcium chloride. Elsevier).

Spodumene mineral is the major source of high-purity lithium, which can exist in α, β, and γ phases (Salakjani, N. K., Singh. P. & Nikoloski, A. N. (2016). Mineralogical transformations of spodumene concentrate from Greenbushes, Western Australia, Part 1: Conventional heating. Minerals Engineering, 98, 71-79 and contains a chemical composition of approximately 8 wt. % of Li2O, 27.4 wt. % Al2O3, and 64.6 wt. % SiO2; Brumbaugh, R, J., & Panus, W E, (1954). Determination of lithium in spodumene by flame photometry. Analytical Chemistry, 26(3), 463465). The α-spodumene phase, which belongs to the pyroxene group, is the naturally occurring crystal structure. β-Spodumene is a recrystallized product that forms when α-spodumene is heated at temperatures above 800 to about 1100° C. The β-spodumene phase has interlocked five-membered rings of (Si, Al)O₄. The γ-spodumene phase is a metastable phase that occurs when α-spodumene is heated at 700-900° C. (Kotsupalo. N, P., Menzheres, L. T., Ryabtsev, A. D., & Boldyrev, V. V, (2010). “Mechanical activation of α-spodumene for further processing into lithium compounds.” Theoretical Foundations of Chemical Engineering, 44(4), 503-507).

Current technologies do not allow leaching of lithium from the α-spodumene phase, and therefore most of the methods of lithium extraction from the spodumene are focused on modifying the crystal structure of concentrated spodumene mineral to the leachable β-spodumene using conventional heating (roasting) at 950-1100° C. Upon phase transformation to β, the spodumene is further mixed with sulfuric acid and heated at a temperature range of about 200-300° C. As a result, the hydrogen ions in the sulfuric acid replace lithium within β-spodumene, and as a result, lithium-ions combine with sulfate ions to form lithium sulfates that can be dissolved in the aqueous solution (U.S. Pat. No. 2,516,109).

However, such high-temperature roasting processes (especially roasting for the transformation of α-spodumene to β-spodumene) are very energy-intensive and have been the bottleneck of the economic extraction of lithium from ores. There have been many studies conducted for the extraction of lithium from β-spodumene, but the literature on the Li recovery from α-spodumene is limited. Therefore, the primary objective of this research is to develop an economically viable process to extract lithium directly from the α-spodumene.

Thus, there is a need for more energy-efficient and environmentally friendly methods for a high-yield extraction of lithium. These needs and other needs are at least partially satisfied by the present disclosure.

### SUMMARY

The present invention is directed to a method of extraction of lithium from mineral sources. The disclosed methods are more energy-efficient and do not require heating to very high temperatures.

In one aspect disclosed herein is a method comprising: a) heating a mixture of a lithium-bearing material provided in a water-insoluble solid form and a solid roasting agent for a first predetermined time to form a solid composition comprising at least one water-soluble phase and at least one water-insoluble phase, wherein the at least one water-soluble phase comprises a first amount of lithium and wherein the at least one water-insoluble phase comprises a second amount of lithium; wherein the heating is at a heating temperature from about 100° C. to less than about 850° C.; b) suspending the solid composition in a first aliquot of water for a second predetermined time, thereby dissolving the at least one water-soluble phase and forming a first suspension comprising a first solid phase and a first liquid phase, wherein the first liquid phase comprises a first portion of the first amount of lithium and wherein the first solid phase comprises the at least one water-insoluble phase comprising the second amount of lithium; c) recovering the first portion of the first amount of lithium from the first liquid phase; and d) optionally: i) suspending the first solid phase in a second aliquot of water for a third predetermined time to form a further suspension comprising a further solid phase and a further liquid phase; ii) recovering a further portion of the first amount of lithium from the further liquid phase; and iii) if the further liquid phase is not substantially free of the further portion of the first amount of lithium in the further liquid phase subjecting the further solid phase to steps i)-ii).

In other aspects, the roasting agent comprises one or more compounds comprising one or more of alkali, alkaline-earth metals, or ammonium-based compounds, or a combination thereof. In yet still further aspects, the lithium-bearing material comprises α-spodumene, lepidolite, hectorite, jadarite, Li-enriched clays, Li-batteries, waste streams of mining and processing of coal and coal by-products and minerals and oil shale, coal underclay, coal overburden, recycled materials, or any combination thereof.

In yet further aspects, the disclosed herein methods further comprise a) adding a first aliquot of an acid to the first solid phase or the further solid phase, if present; b) suspending the first solid phase or the further solid phase, if present, in the amount of acid for a fourth predetermined time to form an additional suspension comprising an additional solid phase and an additional liquid phase, wherein the additional liquid phase comprises a first portion of the second amount of lithium and wherein the additional solid phase comprises a second portion of the second amount of lithium.

Also disclosed are aspects where the method further comprises the sequence of steps: i) step of adding a second aliquot of an acid to the additional solid phase to form a further additional suspension comprising a further additional solid phase and a further additional liquid phase, wherein the further additional liquid phase optionally comprises a further portion of the second amount of lithium; ii) separating the further additional liquid phase and further additional solid phase; if the further additional liquid phase comprises the further portion of the second amount of lithium, the further additional solid phase is further subjected to the steps i)-ii); if the further additional liquid phase is substantially free of the further portion of the second amount of lithium, recycling the further additional liquid phase to the first or the second aliquot of the acid.

Additional aspects of the disclosure will be set forth, in part, in the detailed description, figures, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF DRAWINGS

FIG. 1 depicts a generic flowsheet for lithium extraction.

FIG. 2 depicts a schematic of exemplary process steps in one aspect.

FIG. 3 depicts a schematic of exemplary process steps directed to concentrating a spodumene specimen in one aspect.

FIG. 4 depicts lithium recovery yield using various roasting agents.

FIG. 5 depicts elemental recovery during the water and acid leaching steps performed after roasting a-spodumene with NaOH at 320° C. The error bars show standard errors.

FIG. 6 depicts a temperature vs. time plot of an exemplary microwave heating of a pure spodumene specimen without the presence of roasting agents.

FIG. 7 depicts a recovery yield of various elements when α-spodumene is microwave (1.5 kW) heated with NaOH at 400° C., and the roasted product was subjected to water leaching followed by acid leaching.

FIG. 8 depicts a recovery yield of various elements when coal overburden (clay-enriched shale) is microwave (1.5 kVV) heated with NaOH at 400° C. and the roasted product was subjected to water leaching followed by acid leaching, and the results were compared to acid leaching of non-treated samples.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the singular forms “a,” “an,” and “the” include plural referents unless the context clearly dictates otherwise. Thus, for example, reference to a “water aliquot” includes aspects having two or more water aliquots unless the context clearly indicates otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the terms “optional” or “optionally” mean that the subsequently described event or circumstance may or may not occur, and that the description includes instances where said event or circumstance occurs and instances where it does not.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

It is understood that the weight percentages can be converted to mole percentages if the molar mass of the specific compound or composition is known. In yet further aspects, the mole percentages can be converted to volume percentages if a volume of the specific compound or composition is known.

It is also to be understood that the terminology used herein is for the purpose of describing particular aspects only and is not intended to be limiting. As used in the specification and in the claims, the term “comprising” can include the aspects “consisting of” and “consisting essentially of.” Also, in some aspects, the terms “include,” “including,” and/or “incorporating” can be used. In such aspects, these terms are intended to be interpreted broadly without any limitations.

For the terms “for example” and “such as,” and grammatical equivalences thereof, the phrase “and without limitation” is understood to follow unless explicitly stated otherwise.

As used herein, the term “and/or” includes any and all combinations of one or more of the associated listed items. It is understood that the term “and/or” in some aspects includes either of the associated listed items, while in other aspects, it can include all or any combination of the associated listed items.

It will be understood that, although the terms “first,” “second,” “further,” “additional,” etc., may be used herein to describe various elements, mixtures, compositions, components, regions, layers and/or sections. These elements, mixtures, compositions, components, regions, layers and/or sections should not be limited by these terms. These terms are only used to distinguish one element, mixture, composition, component, region, layer, or section from another element, mixture, composition, component, region, layer, or a section. Thus, a first element, mixture, composition, component, region, layer, or section discussed below could be termed a second element, mixture, composition, component, region, layer, or section without departing from the teachings of example aspects.

As used herein, the term “substantially,” when used in reference to a composition, refers to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by weight, based on the total weight of the composition, of a specified feature or component.

As used herein, the term “substantially,” in, for example, the context “substantially free” refers to a composition having less than about 1% by weight, e.g., less than about 0.5% by weight, less than about 0.1% by weight, less than about 0.05% by weight, or less than about 0.01% by weight of the stated material, based on the total weight of the composition.

As used herein, the term “substantially,” in, for example, the context “substantially identical” or “substantially similar” refers to a method, a composition, article, or a component that is at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by similar to the method, composition, article, or the component it is compared to.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, the terms “substantially identical reference composition” or “substantially identical reference method” refer to a reference composition or method comprising substantially identical components or method steps in the absence of an inventive component or a method step. In another exemplary embodiment, the term “substantially,” in, for example, the context “substantially identical reference compositions,” refers to a reference composition or a method step that comprises substantially identical components or method steps, and wherein an inventive component or a method step is substituted with a common in the art component or a method step.

The term “lithium-bearing material” as used herein refers to any lithium-containing substance. The term may be used predominantly to refer to naturally occurring minerals that contain lithium values, including but not limited to silicates, fluorophosphate, borosilicates, aluminum silicates, phosphates such as amblygonite, lithium-containing micas, and lithium-containing clays. In some aspects, as disclosed herein, the lithium-bearing materials can be used as naturally occurring ores. Yet, in other aspects, the lithium-bearing materials can be used as concentrates.

It will be appreciated by those skilled in the art that the lithium-bearing material may comprise one or more naturally occurring lithium minerals because they frequently occur together, for example, in pegmatite bodies. Several metals, such as Mn, Rb and Cs, and other minerals such as quartz, albite, feldspar, topaz and beryl may also be associated with these lithium minerals. Accordingly, the term “lithium-bearing material” encompasses high-grade ores and concentrates as well as medium to low-grade ores, concentrates and blends thereof.

Exemplary lithium-bearing materials include, but are not limited to, jadarite, spodumene and other pyroxenes, trilithionite, petalite and other lithium-bearing silicates from the nepheline group of minerals, holmquistite and other lithium-bearing silicates from the amphibole group of minerals, lepidolite, zinwaldite, elbaite and other tourmalines, chlorites, smectites, lithium-containing micas, and lithium-containing clays.

Yet, in other aspects, the lithium-bearing material can also refer to man-made materials comprising at least an amount of lithium. For example, and without limitations, the artificial (man-made) lithium-bearing materials can include batteries, printing boards, electronic materials, paints, and the like.

In still further aspects, the lithium-bearing materials can also comprise waster streams of mining and processing of coal and coal by-products and minerals and oil shale, coal underclay, coal overburden, or any combination thereof.

In still further aspects, the lithium-bearing material comprises α-spodumene, lepidolite, hectorite, jadarite, Li-enriched clays, Li-batteries, waste streams of mining and processing of coal and coal by-products and minerals and oil shale, coal underclay, coal overburden, recycled materials, or any combination thereof.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Methods

The present disclosure relates to a method for the recovery of lithium from lithium-bearing materials. It is understood that in certain aspects, the methods disclosed herein are batch processes. While in other aspects, the methods disclosed herein are continuous processes. It is also understood that the mixed processes can also be utilized.

In certain aspects, the methods disclosed herein comprise heating a mixture of a lithium-bearing material provided in a water-insoluble solid form and a solid roasting agent for a first predetermined time to form a solid composition comprising at least one water-soluble phase and at least one water-insoluble phase. In such aspects, the at least one water-soluble phase comprises a first amount of lithium and wherein the at least one water-insoluble phase comprises a second amount of lithium. In still further aspects, the heating is performed at a heating temperature from about 100° C. to less than about 850° C.

In still further aspects, the step of heating can be at any temperature. In still some other aspects, the heating can be performed at a heating temperature from about 100° C. to less than about 850° C., including exemplary values of about 150° C., about 200° C., about 250° C., about 300° C., about 350° C., about 400° C., about 450° C., about 500° C., about 550° C., about 600° C., about 650° C., about 700° C., about 750° C., and about 800° C. In yet further aspects, the heating can be performed at a heating temperature of less than about 850° C., less than about 800° C., less than about 775° C., less than about 750° C., less than about 725° C. less, than about 700° C., less than about 675° C., less than about 650° C., less than about 625° C., less than about 600° C., less than about 575° C., less than about 550° C., less than about 525° C., less than about 500° C., less than about 475° C., less than about 450° C., less than about 425° C., less than about 400° C., less than about 375° C., less than about 350° C., less than about 325° C., less than about 300° C., less than about 275° C., less than about 250° C., less than about 225° C., less than about 200° C., less than about 175° C., less than about 150° C., or less than about 125° C. In yet further aspects, the heating can be done at any temperature between any two foregoing values.

In still further aspects, the heating can be done at a temperature substantially identical to the melting point of the roasting agent. In yet other aspects, the heating can be done at temperatures above the melting point of the roasting agent. While on other aspects, the heating can be done at temperatures below the melting point of the roasting agent. In yet other exemplary and unlimiting aspects, if the mixture of the compound is present, the heating can be performed at a temperature close or substantially identical to the eutectic point of the mixture. However, it is also understood that some of the mixtures of the roasting agents may not have a eutectic point or have or more eutectic points. In such aspects, the temperature can be chosen to achieve the desired results.

In still further aspects, any of the disclosed herein method steps can also be performed under pressure from about 0.1 MPa to about 20 MPa, including exemplary values of 0.5 MPa, about 1 MPa, about 2 MPa, about 3 MPa, about 3 MPa, about 4 MPa, about 5 MPa, about 6 MPa, about 7 MPa, about 8 MPa, about 9 MPa, about 10 MPa, about 11 MPa, about 12 MPa, about 13 MPa, about 14 MPa, about 15 MPa, about 16 MPa, about 17 MPa, about 18 MPa, and about 19 MPa.

In some aspects, the heating step can be performed under the disclosed elevated pressure. It is understood that in certain aspects, increasing the pressure can allow a decrease in the temperature in the heating step.

It is understood that any known in the art heating methods can be utilized. In certain aspects, the step of heating comprises the use of a heated chamber comprising one or more heating sources effective to provide the heating temperature as desire. It is understood that the heated chamber can be a conventional oven, a rotary kiln, a furnace, a thermal shock chamber, etc. Any heating sources can be utilized and can comprise gas or oil based heaters, electrical heaters, IR heaters, UV heaters, microwave heaters, solar heaters, and the like. In still further aspects, the one or more heating sources comprise a microwave heating source. In such exemplary and unlimiting aspects, the microwave source can have a frequency between about 900 MHz to about 6 GHz, including exemplary values of about 915 MHz, 2.45 GHz, or 5.8 GHz. However, any other allowable frequencies in the disclosed range can also be utilized.

In still further aspects, the microwave source can have an energy between about 500 W and about 40 kW, including exemplary values of about 1 kW, about 5 kW, about 10 kW, about 15 kW, about 20 kW, about 25 kW, about 30 KW, and about 35 kW.

In yet further aspects, the microwave source can have a frequency between about 900 MHz to about 6 GHz, including exemplary values of about 915 MHz, 2.45 GHz, or 5.8 GHz, and an energy between about 500 W and about 40 kW, including exemplary values of about 1 kW, about 5 kW, about 10 kW, about 15 kW, about 20 kW, about 25 kW, about 30 KW, and about 35 kW. Without wishing to be bound by any theory, it was hypothesized that the use of the microwave heating source could improve lithium recovery yield. It was further hypothesized that due to the microwave internal heating characteristics and increased host mineral porosity, the required temperature of the chemical reaction and sintering time can be substantially reduced when compared to similar parameters when conventional heating sources are utilized.

In some aspects, the formed solid composition can be washed and dried before any further processing steps. In such exemplary aspects, the washing can allow removal of un-reacted chemicals. It is understood, however, that if a washing step is present, the liquid phase from the washing process can be collected, and any of the dissolved lithium present in the phase can be recovered. It is understood that in some aspects, these optional washing and drying steps can also be performed under the disclosed elevated pressures. Yet, in other aspects, the optional washing and drying steps can also be performed under vacuum.

In yet further aspects, the formed solid composition can be further size reduced before any further processing steps.

In still further aspects, the formed solid composition can be then suspended in a first aliquot of water for a second predetermined time, thereby dissolving the at least one water-soluble phase and forming a first suspension comprising a first solid phase and a first liquid phase. In such aspects, the first liquid phase can comprise a first portion of the first amount of lithium, while the first solid phase can comprise the at least one water-insoluble phase comprising the second amount of lithium. In still further aspects, the methods disclosed herein comprise recovering the first portion of the first amount of lithium from the first liquid phase. It is also understood that the steps of suspension in any of the disclosed herein water aliquotes can also be performed under any of the disclosed herein elevated pressures. In still further aspects, the steps of forming suspensions in the water aliquots can also be referred to as water leaching steps.

In certain aspects, the first and/or the further, if present, aliquot of water can comprise a distilled water. In still further aspects, the first and/or the further, if present, aliquot of water can comprise recycled the first and/or the further liquid phase as described herein. In still further aspects, this recycled liquid phase can comprise some amount of lithium that was not recovered in previous steps. In yet other aspects, the first or the further aliquot of water can comprise one or more additives configured to improve the solubility of lithium in the water. In such exemplary and unlimiting aspects, the additives can participate in further change in the phases of the solid composition formed after the heating step. In still further aspects, the one or more additives can comprise one or more salts. In such exemplary aspects, any of the water aliquots can comprise an electrolyte. In yet other aspects, the additive can comprise a buffer. It is understood that any additives that can affect phase change in the lithium-bearing material phase or improve lithium solubilization in water can be used. Similarly, if desired, any of the water aliquots can also comprise additives that improve solubilization of one or more of aluminum, calcium, iron, silicon, sodium, or at least one of rare earth elements.

It is understood that the recovering of the first portion of the first amount of lithium from the first liquid phase can be done by any known in the art methods without any limitations. In some exemplary and unlimiting aspects, the recovery can comprise forming lithium hydroxide, lithium chloride, and/or lithium carbonate by any known in the art methods.

In still further aspects, prior to the step of recovery, the first liquid phase can be analyzed for the presence of lithium. It is understood that the analysis of the lithium can be done manually or automatically, for example, by removing a small portion of the liquid phase for elemental analysis.

It is also understood that the step of recovery can also include a step of separation of the first liquid phase from the first solid phase. The separation can include any known in the art methods. For example, separation can comprise conventional separation techniques such as, for example, filtration, gravity separation, centrifugation and so forth. It will be appreciated by those skilled in the art that additives such as clarifying agents and/or thickeners may be mixed into the suspension to separating solids from liquids to facilitate efficient separation thereof.

In still further aspects, the method can further comprise i) suspending the first solid phase in a second aliquot of water for a third predetermined time to form a further suspension comprising a further solid phase and a further liquid phase; ii) recovering a further portion of the first amount of lithium from the further liquid phase; and iii) if the further liquid phase is not substantially free of the further portion of the first amount of lithium in the further liquid phase subjecting the further solid phase to steps i)-ii). It is understood that in some aspects, the steps of suspending the first solid phase in the second aliquot of water for additional water leaching of lithium can be optional. However, if this step is present, this step can be repeated any number of times. Similarly, this step can also be performed under any of the elevated pressures disclosed herein. In some aspects, these optional steps can be performed as long a substantial amount of lithium can be recovered from each subsequent liquid phase, for example. Again, and as disclosed above, the step of recovery can comprise separation of the further liquid phase from the further solid phase. When the further liquid phase is substantially free of lithium, this further liquid phase can be recycled into the first or the second water aliquot. It is also understood that after recovery of lithium or any other of the disclosed herein elements from any one of the disclosed herein liquid phases, such a liquid phase can be recycled back into the process. It is further understood that in such exemplary aspects, any of the disclosed herein water aliquots can comprise any additives as described above.

In yet other aspects, if the process is present and if the further liquid phase is substantially free of the further portion of the first amount of lithium recycling the further liquid phase to the first aliquot of water. In such exemplary aspects, the further solid phase obtained in this step can be then collected for further processing. It is also understood that the term “substantially free,” as used for example herein, refers to the liquid phase having less than about 1% of lithium, less than about 0.5% of lithium, less than about 0.3% of lithium, less than about 0.1% of lithium, less than about 0.05% of lithium, or less than about 0.01% of lithium. In still further aspects, the term “substantially free” can also refer to less than 1,000 ppm of lithium, less than 800 ppm of lithium, less than 500 ppm of lithium, less than 100 ppm of lithium, or less than 50 ppm of lithium.

It is understood, however, as discussed in detail above, that repetitive exposure of each sequential solid phase to the water leaching process as described is optional. In certain aspects, the first solid phase is formed after a first time the solid mixture is exposed to the first water aliquot is collected for further processing without any additional steps of water leaching.

In certain aspects, the lithium-bearing material can comprise any known in the art natural and artificial materials that comprise at least an amount of lithium. α-spodumene, lepidolite, hectorite, jadarite, Li-enriched clays, Li-batteries, recycled materials, waste streams of mining and processing of coal and coal by-products and minerals and oil shale, coal underclay, coal overburden, recycled materials, or any combination thereof. It is understood that any known in the art naturally occurring or artificial materials can be used as a lithium-bearing material of the present disclosure.

In some aspects, the lithium-bearing material can be provided in its original form. Yet, in other aspects, the lithium-bearing material can undergo some processing steps, such as, for example, and without limitation, purification, size-reduction, concentration, etc.

It is understood that, for example, the step of purification can include removal of debris, unnecessary fillers, or materials that can adversely affect the further processing steps of the current disclosure. In some aspects, the steps of purification can include chemical purification, mechanical purification, or physical purification.

In yet other aspects, the process steps can also include the concentration of the lithium-bearing materials prior to the heating step with the roasting agent.

It is understood that the steps of concentration can comprise the separation of impurities from the grinding mill, for example. Such a separation, for example, and without limitations, can be size, optical, gravity separation, magnetic and electrostatic separation, and/or flotation separation.

In certain aspects, the lithium-bearing material can be used as provided. While in other aspects, it can be size-reduced. Exemplary particle size distribution characteristics to be replicated can include predetermined values of D(n), where (n) represents a mass percentage such as 5%, 10%, 15%, 20%, 25%, 30%, 35%, 40%, 45%, 50%, 55%, 60%, 65%, 70%, 75%, 80%, 85%, 90%, 95%, or 100%. The value of D(n) thus represents the particle size of which (n) percentage of the mass is finer. For example, the quantity D₍₁₀₀₎ represents the particle size of which 100% of a mass is finer. The quantity D₍₇₅₎ represents the particle size of which 75% of a mass is finer. The quantity D₍₅₀₎ is the median particle size of a mass, for which 50% of the mass is finer. The quantity D₍₂₅₎ represents the particle size of which 25% of a mass is finer. The quantity D₍₁₀₎ represents the particle size of which 10% of a mass is finer.

In some exemplary aspects, the lithium-bearing material can be size-reduced to D₍₈₀₎ in a range from about 20 μm to about 5 mm, including exemplary values of about 30 μm, about 40 μm, about 50 μm, about 60 μm, about 70 μm, about 80 μm, about 90 μm, about 100 μm, about 125 μm, about 150 μm, about 175 μm, about 200 μm, about 225 μm, about 250 μm, about 275 μm, about 300 μm, about 325 μm, about 350 μm, about 375 μm, about 400 μm, about 425 μm, about 450 μm, about 475 μm, about 500 μm, about 525 μm, about 550 μm, about 575 μm, about 600 μm, about 625 μm, about 650 μm, about 675 μm, about 700 μm, about 725 μm, about 750 μm, about 775 μm, about 800 μm, about 825 μm, about 850 μm, about 875 μm, about 900 μm, about 925 μm, about 950 μm, about 975 μm, about 1 mm, about 1.2 mm, about 1.5 mm, about 1.7 mm, about 2 mm, about 2.2 mm, about 2.5 mm, about 2.7 mm, about 3 mm, about 3.2 mm, about 3.5 mm, about 3.7 mm, about 4 mm, about 4.2 mm, about 4.5 mm, and about 4.7 mm.

In yet further aspects, the lithium-bearing material can be ground and milled to the desired particle size by conventional techniques well known in the art in a dry milling process or a wet milling process.

In still further aspects, the lithium-bearing material of any of the disclosed above aspects is mixed with the solid roasting agent.

It is understood that the mixture can be formed by any known in the art methods, for example, the lithium-bearing material and the roasting agent can be crushed together, ground together, and/or blended. In yet other aspects, the formed mixture is homogeneous. In certain aspects, the homogeneous mixture can be obtained using a blending silo that can comprise a recirculation line to recirculate and blend the roasting agent within the lithium-bearing material. In yet other aspects, the at least one blending silo can comprise multiple flow channels to help blend the roasting materials within the lithium-bearing materials. In certain aspects, blending can also help with a reduction in the variation of particle sizes and thus in a more efficient roasting reaction between the lithium-bearing material and the roasting agent. However, it is understood that in some exemplary and unlimiting aspects where the roasting agent is hydrophilic and can easily absorb moisture, the blending can be done under an inert atmosphere or under reduced pressure to keep moisture out of the mixture.

In still further aspects, the solid roasting agent can comprise one or more compounds comprising one or more of alkali, alkaline-earth metals, or ammonium-based compounds, or a combination thereof. It is understood that the compounds chosen as the roasting agents can comprise salt, hydroxides, oxides, carbonate, sulphate, nitrate, chloride or any combination thereof. It is further understood that these compounds can be present in a pure form but can also comprise impurities in any amount that does not substantially affect the methods disclosed herein.

In still further aspects, the one or more compounds can comprise NaOH, Na₂CO₃, KOH, K₂CO₃, MgCO₃, CaCO₃, BaCO₃, NaCl, KCl, CaCl₂, MgCl₂, NaNO₃, KNO₃, Ca(NO₃)₂, Ba(NO₃)₂, Mg(NO₃)₂, Ca(OH)₂, CaSO₄, (NH₄)₂SO₄, Na₂SO₄, or any combination thereof. Yet, in other aspects, the roasting agent can comprise at least an amount of NaOH. In certain aspects, any of the disclosed above compounds can be used as a stand-alone roasting agent or used in any combination with any of the disclosed above compounds. Again, it is further understood that in some exemplary and unlimiting aspects, the mixing and use of roasting agents can be done under an inert atmosphere or under reduced pressure to minimize moisture content.

Without wishing to be bound by any theory, it is hypothesized that use of the solid roasting agent as disclosed herein can react with the lithium-bearing material to break the bonds and to make at least a portion of the lithium-bearing material water-soluble, thereby allowing leaching of lithium to the first water aliquot.

It is understood that the methods disclosed herein allow reduction processing steps when compared with traditional methods of lithium recovery. For example, the methods disclosed herein allow the use of unprocessed lithium-bearing material and solubilization of lithium therefrom at temperatures and pressures that are substantially lower than ones used in the traditional methods. Also, without wishing to be bound by any theory, it is understood that the use of the solid roasting agent minimizes the use of corrosive materials and allows a direct reaction with the lithium-bearing material. It is understood that roasting with solid roasting agents allows a reduction in the use of highly corrosive liquids. In such aspects, the reaction allows the phase transformation of the lithium-bearing material and formation of the water soluble phases.

In still further aspects, the lithium-bearing material can comprise additional materials that are not lithium. In some aspects, these additional materials can comprise additional elements, such as, for example, aluminum, calcium, iron, silicon, sodium, at least one of rare earth materials, transition metals, such as molybdenum, and the like.

In the aspects when the first solid phase is formed, the first solid phase can also comprise one or more of aluminum, calcium, iron, silicon, sodium, or at least one of rare earth elements. However, it is also understood that some of these additional materials can also be dissolved in the first aliquot of water and transfer to the first liquid phase. In such exemplary aspects, the first liquid phase can also further comprise a first amount of one or more of aluminum, calcium, iron, silicon, sodium, or at least one of rare earth elements. In certain aspects, the methods also include steps of recovering one or more of aluminum, calcium, iron, silicon, sodium, or at least one of rare earth elements. Any known in the art methods for recovery of these elements can be utilized. However, it is further understood that the first amount of aluminum is not the same as the first amount of calcium if both of these elements are present, and so on. In yet further aspects, the first amount of each of the disclosed above elements can be determined by their original concentration in the lithium-bearing material, the strength of their bonds within the lithium-bearing material and their solubility in water. In such exemplary aspects, the yield of recovery of any of the disclosed above additional elements that are different from Li in the first liquid phase or any further liquid phase, if present, can be lower than the yield of recovery of Li. If the step of treating the first solid phase with the further aliquot of water is present to form the further solid phase and the further liquid phase, each of these phases can comprise a further amount of the one or more of aluminum, calcium, iron, silicon, sodium, or at least one of rare earth elements.

In still further aspects, any of the disclosed herein lithium-bearing materials can be mixed with any of the disclosed above roasting agents in any desired ratio. In some aspects, the mixture can comprise a ratio of the roasting agent to the lithium-bearing material between about 0.1:1 to about 10:1, wherein the ratio is calculated by the weight of the roasting agent to the weight of the lithium-bearing material. Some exemplary and unlimiting ratios can include about 0.1:1, about 0.2:1, abut 0.3:1, about 0.4:1, about 0.5:1, about 0.6:1, about 0.7:1, about 0.8:1, about 0.9:1, about 1:1, about 2:1, about 3:1, about 4:1, about 5:1, about 6:1, about 7:1, about 8:1, about 9:1, and about 10:1.

In certain aspects, the first predetermined time is from about 0.5 seconds to about 24 hours, including exemplary values of about 1 s, about 5 s, about 10 s, about 30 s, about 1 min, about 5 min, about 15 min, about 30 min, about 45 min, about 1 h, about 2 h, about 5 h, about 10 h, about 15 h, or about 20 h.

In still further aspects, the first suspension and/or the further suspension, if present, are suspended in the respective water aliquot for the second predetermined time and/or the third predetermined time from about 1 min to about 72 hours, including exemplary values of about 5 min, about 10 min, about 15 min, about 30 min, about 45 min, about 1 h, about 5 h, about 10 h, about 15 h, about 20 h, about 24 h, about 30 h, about 36 h, about 42 h, about 48 h, about 52 h, about 60 h, and about 70 h.

In still further aspects, the first suspension or the further suspension, if present, can be heated during the suspension time. In some aspects, the first and/or the further suspension, if present, can be suspended in water at room temperature for some predetermined time and then heated. Yet, in other aspects, the first and/or the further suspension, if present, can be suspended in heated water and continued to be heated for the second predetermined time and/or third predetermined time, respectively. In such aspects, the first suspension and/or third suspension, if present, are heated at a temperature from about 20° C. to about 100° C., including exemplary values of about 25° C., about 30° C., about 35° C., about 40° C., about 45° C., about 50° C., about 55° C., about 60° C., about 65° C., about 70° C., about 75° C., about 80° C., about 85° C., about 90° C., and about 95° C.

In still further aspects, the step of suspending can also comprise mixing the first suspension or the further suspension if present. It is understood that any known in the art mixing techniques can be utilized. In some aspects, the mixing step can comprise stirring, agitating, blending, and the like. The specific intensity of the mixing procedures can be determined by one of ordinary skill in the art depending on the desired outcome.

In still further aspects, the first portion of the first amount of lithium is at least 5% of all lithium present in the lithium-bearing material. In yet other aspects, the first portion of the first amount of lithium is from about 5% to less than 100% of all lithium present in the lithium-bearing material, including exemplary values of about 10%, about 20%, about 30%, about 40%, about 50%, about 60%, about 70%, about 80%, about 90%, about 95%, and about 99%. In yet other aspects, a sum of the first portion and the further portion if present of the first amount of lithium is from about 5% to less than 100% of all lithium present in the lithium-bearing material, including exemplary values of about 10%, about 20%, about 30%, about 40%, about 50%, about 60%, about 70%, about 80%, about 90%, about 95%, and about 99%.

In still further aspects, the method comprises collecting the first solid phase or the further solid phase, if present.

In yet other aspects, the method further comprises a) adding a first aliquot of an acid to the first solid phase or the further solid phase, if present; b) suspending the first solid phase or the further solid phase, if present, in the amount of acid for a fourth predetermined time to form an additional suspension comprising an additional solid phase and an additional liquid phase, wherein the additional liquid phase comprises a first portion of the second amount of lithium and wherein the additional solid phase comprises a second portion of the second amount of lithium.

It is understood that in certain aspects, the water-based leaching allows a reduction in the amount of the materials present in the solid phase prior to the addition of the first aliquot of the acid and thereby, it also allows a reduction in the amount of required acid

In still further aspects, the method further comprises recovering the first portion of the second amount of lithium from the additional liquid phase. It is understood that any known in the art methods for recovery of lithium can be utilized. Again, as disclosed above, lithium can be recovered as lithium hydroxide, lithium chloride, and/or lithium carbonate, or in any other acceptable form. Similar to the aspects disclosed above, the step of recovery can also include first separating the additional liquid phase from the additional solid phase.

In still further aspects, the fourth predetermined time is from about 1 min to about 72 hours, including exemplary values of about 5 min, about 10 min, about 15 min, about 30 min, about 45 min, about 1 h, about 5 h, about 10 h, about 15 h, about 20 h, about 24 h, about 30 h, about 36 h, about 42 h, about 48 h, about 52 h, about 60 h, and about 70 h.

In other aspects, the step of suspending the first solid phase or the further solid phase, if present, can further comprise a step of mixing the additional suspension. Any of the disclosed above mixing methods can be used for this purpose.

In yet further aspects, the step of suspending the first solid phase or the further solid phase if present can further comprise keeping the additional suspension at a temperature from about 20° C. to about 300° C., including exemplary values of about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 115° C., about 125° C., about 150° C., about 175° C., about 200° C., about 215° C., about 225° C., about 250° C., and about 275° C.

In still further aspects, the additional liquid phase can comprise a second amount of one or more of aluminum, calcium, iron, silicon, sodium, or at least one of rare earth elements. In such exemplary aspects, the methods can also comprise recovering the second amount of one or more of aluminum, calcium, iron, silicon, sodium, or at least one of rare earth elements.

As discussed above, is it also understood that the second amount of any of the additional elements disclosed above is not necessarily the same. For example, the second amount of aluminum is not the same as the second amount of calcium or silicon if all or any of those elements are present, and so on. In yet further aspects, the second amount of each of the disclosed above elements can be higher than the first amount (or further amount) of these elements after the water leaching step. Again, without wishing to be bound by any theory, it was assumed that while the first roasting step can modify the bonding of Li in the lithium-bearing material to make it water-soluble, it does not necessarily happen to other elements that can also be present in the lithium-bearing material. In such aspects, the elements can stay in the water-insoluble phase and can be only leached out by the acid leaching process, as discussed herein. Even further, the yield of recovery of any of the disclosed here of the additional elements can also be dependent on the concentration of the acid or the pH of the liquid phase obtained after the addition of the acid.

In yet other aspects, the disclosed method further comprises collecting the additional solid phase. In certain optional and exemplary aspects, the method can also comprise the sequence of steps: i) step of adding a second aliquot of an acid to the additional solid phase to form a further additional suspension comprising a further additional solid phase and a further additional liquid phase, wherein the further additional liquid phase optionally comprises a further portion of the second amount of lithium; ii) separating the further additional liquid phase and further additional solid phase; if the further additional liquid phase comprises the further portion of the second amount of lithium, the further additional solid phase is further subjected to the steps i)-ii); if the further additional liquid phase is substantially free of the further portion of the second amount of lithium, recycling the further additional liquid phase to the first or the second aliquot of the acid. Similar to the aspects disclosed above, the further additional liquid phase can be separated from the further additional solid phase.

In certain aspects, any of the present herein aliquots of the acid can also comprise some amount of lithium that was not recovered. In still further aspects, any of the present herein aliquots of the acid can comprise recycled liquid phases as described herein. In yet other aspects, any of the present herein aliquots of the acid can comprise one or more additives configured to improve the solubility of lithium in acid. In such exemplary and unlimiting aspects, the additives can participate in a further change of the phases of the solid phase obtained after the water leaching step. In still further aspects, the one or more additives can comprise one or more salts. In yet other aspects, the additive can comprise a buffer. It is understood that any additives that can affect phase change in the lithium-bearing material or improve lithium solubilization in acid can be used. Similarly, if desired, the acid can also comprise additives that improve solubilization of one or more of aluminum, calcium, iron, silicon, sodium, or at least one of rare earth elements.

In yet still further aspects, the method can also comprise combining the additional liquid phase and each of the further additional liquid phases. In such exemplary aspects, all portions of the second amount of lithium can then be recovered.

In still further aspects, the overall Li recovery from the water leachate and acid leachate can be anywhere between about 5% to 100%, including exemplary values of about 10%, about 20%, about 30%, about 40%, about 50%, about 60%, about 70%, about 80%, about 90% , about 95%, about 99%, and about 99.99%.

In still further aspects, the overall recovery of the one or more of aluminum, calcium, iron, silicon, sodium, or at least one of rare earth elements recovery from the water leachate and acid leachate can be anywhere between about 5% to 100%, including exemplary values of about 10%, about 20%, about 30%, about 40%, about 50%, about 60%, about 70%, about 80%, about 90%, about 95%, about 99%, and about 99.99%

It is understood that any acids known in the art can be used. In still further aspects, the acid can comprise H₂SO₄, HCl, H₃PO₄, HNO₃, or any combination thereof. In some aspects, the acids are added in an amount and in concentration to obtain the additional suspension having pH lower than 4, lower than 3.5, lower than 3, lower than 2.5, lower than 2, lower than 1.5, or even lower than 1. In yet further aspects, the acids are added in an amount and in concentration to obtain the additional suspension having pH from 0 to about 4, including exemplary values of about 0.5. about 1, about 1.5, about 2, about 2.5, about 3, and about 3.5. In still further aspects, any of the steps where at least one aliquot of acid is added can also be conducted under elevated pressure from about 0.1 MPa to about 20 MPa, including exemplary values of about 0.5 MPa, about 1 MPa, about 2 MPa, about 3 MPa, about 3 MPa, about 4 MPa, about 5 MPa, about 6 MPa, about 7 MPa, about 8 MPa, about 9 MPa, about 10 MPa, about 11 MPa, about 12 MPa, about 13 MPa, about 14 MPa, about 15 MPa, about 16 MPa, about 17 MPa, about 18 MPa, and about 19 MPa.

In yet other aspects, any of the aliquots of the acid disclosed herein can also comprise additives configured to further improve lithium solubilization and increase the yield of the Lit recovery.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for.

Unless indicated otherwise, parts are parts by weight, temperature is degrees C. or is at ambient temperature, and pressure is at or near atmospheric.

### Example 1

A representative sample of North Carolina spodumene was obtained and concentrated through physical separation. The elemental characterization of the concentrated spodumene is provided in Table 1.

TABLE 1
Elemental concentration of the concentrated spodumene

| Al₂O₃ | CaO | Fe₂O₃ | Li₂O | Na₂O | SiO₂ |
|---|---|---|---|---|---|
| (%) | (%) | (%) | (%) | (%) | (%) |
| 25.1 | 0.66 | 0.73 | 5.64 | 1.06 | 65.7 |

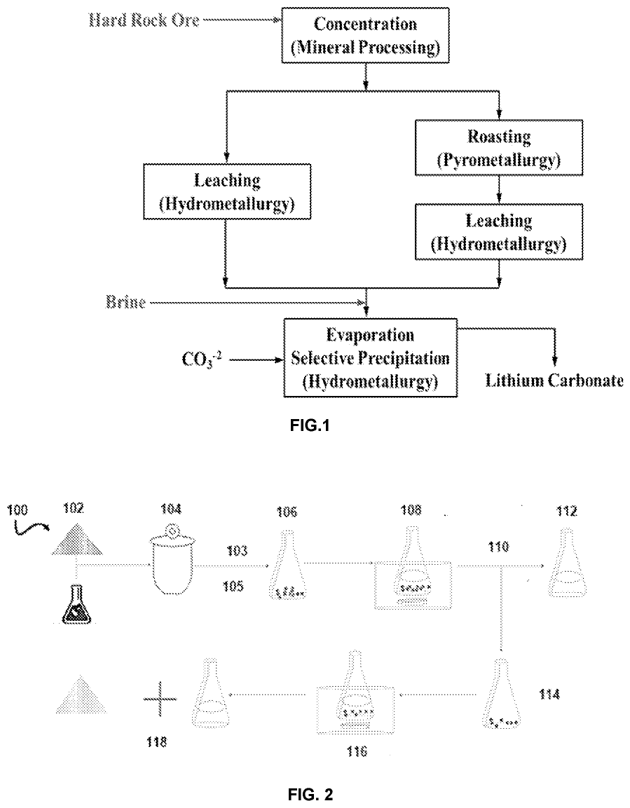

The schematic of process 102 is demonstrated in FIG. 2. A 2-gram representative concentrated spodumene sample was mixed with 3 grams of NaOH in step 102 (i.e., NaOH: spodumene ration of 1.5) in a chromium crucible and then roasted at 318° C. (at a temperature substantially identical to a melting point of NaOH) in an oven for two hours (step 103). The sample was then washed (step 103) and dried (step 105). After that, the dried sample was transferred to a beaker, and 200 ml of water was added to the sample (step 106). The beaker was kept in a water bath with a temperature of 80° C., and the solution was stirred using an overhead stirrer with 450 rpm for two hours (step 108).

The solution was then filtered (step 110) to separate the leachate (112) and solid sample (114). The solid sample was then transferred again to a beaker, and 200 ml of 6 M sulfuric acid was added to the beaker, and the solution was stirred at 450 rpm for two hours at room temperature (step 116). The solution was then filtered to separate solid and leachate (step 118). The leachate obtained from water and acid leaching processes and the remaining solid of the acid leaching (which was weighted, dried and digested according to ASTM D6357-11) were analyzed for Li, Si, and Al content to calculate recovery values of leaching processes.

The elemental content of the leachates obtained during water leaching and acid leaching processes were analyzed using Inductivity Coupled Plasma-Optical Emission Spectrometry (ICP-OES) at the Energy and Environmental Sustainability Laboratories (EESL) within the Penn State Institute of Energy and the Environment. The leaching efficiencies were determined based on the elemental recovery values representing the percentage of each element in spodumene dissolved in the leachates (e.g., Li recovery in the water leaching=(amount of Li dissolved in water/amount of Li in the spodumene used in the experiment)×100=(Li concentration in leachate×Vol. .of leachate/Li concentration in spodumene x Weight of spodumene)×100.

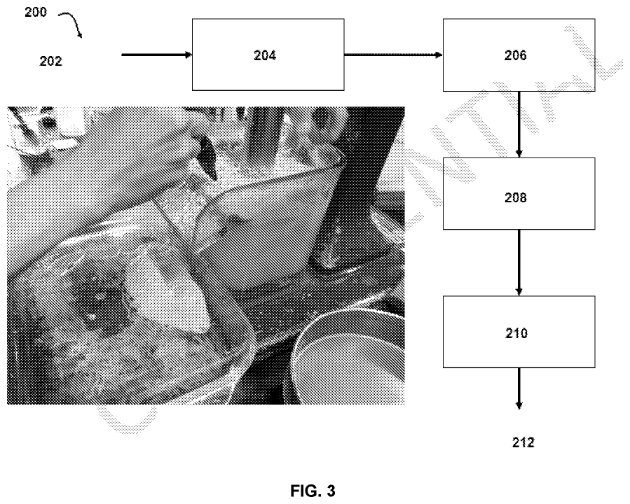

An exemplary process 200 for obtaining a concentrated a-spodumene is shown in FIG. 3. An original ore 202 is crushed (204), ground and deslimed (step 206), a flotation is then used to separate solids from the liquid (208) and then magnetically separated (210) to obtain a concentrated a-spodumene (212) having a LiO₂>6%.

To evaluate the importance of process parameters on lithium recovery through phase transformation of spodumene followed by water leaching, a two-level statistically designed program was conducted. The ranges of parameter values evaluated are shown in Table 2.

TABLE 2
Parameter value ranges investigated
in the 2-level test program

| Process Parameter | Low | High |
|---|---|---|
| Roasting Temperature (° C.) | 320 | 600 |
| Roasting Time | 5 | 30 |
| NaOH:Spodumene Ratio | 1 | 3 |
| Leaching Time (hr) | 1 | 4 |
| Leaching Temperature (° C.) | 25 | 80 |
| Stirring Rate (rpm) | 200 | 450 |

It was found, as shown in FIG. 5, that the NaOH roasting is very effective in phase transformation of α-spodumene to soluble forms as about 70% of Li was released in water during water leaching and most of the remaining Li was released during the acid leaching. Therefore, more than 95% of Li was recovered through water and acid leaching without calcination at high temperatures. The results of Li, Si, and Al recovery are shown in FIG. 5. In addition to the high recovery of Li in water leaching, the low recovery of other elements in water leaching is another advantage of the proposed method as it minimizes the downstream purification process. The results also showed high Al recovery can also be achieved through acid leaching. Thus, the current methods can be useful in maximizing resource utilization and producing Al as a by-product.

Table 3 shows the average recovery values for Li, Al, and Si obtained from three repeat tests with the corresponding standard deviation values in water and acid leaching experiments as they correspond to FIG. 5.

TABLE 3
Elemental recovery yield.

| | Leaching | Element | | |
|---|---|---|---|---|
| Parameter | Type | Al | Li | Si |
| Recovery | Water | 6.55 | 69.38 | 26.53 |
| (%) | Leaching | | | |
| | Acid | 82.98 | 14.33 | 7.69 |
| | Leaching | | | |
| Standard | Water | 0.23 | 1.53 | 2.00 |
| deviation | Leaching | | | |
| | Acid | 8.65 | 2.15 | 6.54 |
| | Leaching | | | |

To maximize Li's recovery during the water leaching to avoid any acid consumption for lithium recovery, a two-level design experiment was conducted to evaluate the most effective parameters in Li's recovery in water leaching. Parameters of roasting and water leaching were examined as described in Table 2. The results of the experimental design are listed in Table 4. The data showed up to 88% Li recovery in non-optimized conditions.

TABLE 4
Summary of independent parameters and measured
values for the response variable

| Parameters | | | | | | | | |
|---|---|---|---|---|---|---|---|---|
| | | | | | Stir- | | | |
| Roast. | Roast | | Leach. | Leach. | ring | | | |
| T | t | NaOH: | t | T | Rate | Recovery (%) | | |
| (° C.) | (min) | Spod. | (hr) | (° C.) | (rpm) | Li | Si | Al |
| 320 | 5 | 1 | 1 | 25 | 200 | 22.96 | 16.46 | 2.19 |
| 600 | 5 | 1 | 1 | 80 | 200 | 45.59 | 17.24 | 3.57 |
| 320 | 30 | 1 | 1 | 80 | 450 | 47.17 | 21.02 | 2.92 |
| 600 | 30 | 1 | 1 | 25 | 450 | 51.17 | 19.96 | 2.52 |
| 320 | 5 | 3 | 1 | 80 | 450 | 7.71 | 11.74 | 8.10 |
| 600 | 5 | 3 | 1 | 25 | 450 | 54.49 | 24.02 | 6.12 |
| 320 | 30 | 3 | 1 | 25 | 200 | 2.98 | 17.78 | 6.76 |
| 600 | 30 | 3 | 1 | 80 | 200 | 34.70 | 11.54 | 4.48 |
| 320 | 5 | 1 | 4 | 25 | 450 | 25.27 | 17.78 | 1.49 |
| 600 | 5 | 1 | 4 | 80 | 450 | 51.98 | 18.22 | 3.02 |
| 320 | 30 | 1 | 4 | 80 | 200 | 38.14 | 18.80 | 2.98 |
| 600 | 30 | 1 | 4 | 25 | 200 | 39.49 | 7.89 | 0.90 |
| 320 | 5 | 3 | 4 | 80 | 200 | 10.03 | 14.40 | 10.07 |
| 600 | 5 | 3 | 4 | 25 | 200 | 85.91 | 7.36 | 8.45 |
| 320 | 30 | 3 | 4 | 25 | 450 | 7.02 | 36.27 | 14.93 |
| 600 | 30 | 3 | 4 | 80 | 450 | 87.89 | 14.64 | 9.09 |

The analysis of variance (ANOVA) of the 2-level design is shown in Table 5. The model was found to be significant. The roasting temperature and NaOH: spodumene, along with their interactions, were found to be the most effective parameters, followed by leaching time and temperature and stirring rate. These parameters will be used for process optimization for maximizing Li recovery in water leaching in the next step of the research.

### Example 2

Various roasting chemicals were also examined to determine the most effective chemical in phase transformation of spodumene mineral to water or acid soluble phases through the breakage of the bonds. Additional chemicals that were tested included CaCl₂, CaSO₄, Ca(OH)₂, (NH₄)₂SO₄, Na₂CO₃, NaCl, Na₂SO₄, and KOH.

TABLE 5
Statistical significance of the parameters and their
associated interactions obtained through ANOVA
analysis of the two-level experimental design

| | Sum of | | Mean | | | |
|---|---|---|---|---|---|---|
| Source | Squares | df | Square | F-value | p-value | |
| Model | 14.21 | 13 | 1.09 | 299.43 | 0.0033 | significant |
| Roasting | 7.03 | 1 | 7.03 | 1926.33 | 0.0005 | |
| Temperature | | | | | | |
| (° C.) | | | | | | |
| C- NaOH: | 1.81 | 1 | 1.81 | 494.9 | 0.002 | |
| Spodumene | | | | | | |
| D- Leaching | 0.3192 | 1 | 0.3192 | 87.42 | 0.0112 | |
| Time | | | | | | |
| (hr) | | | | | | |
| E- Leaching | 0.2943 | 1 | 0.2943 | 80.59 | 0.0122 | |
| Temperature | | | | | | |
| (° C.) | | | | | | |
| F- Stirring Rate | 0.195 | 1 | 0.195 | 53.41 | 0.0182 | |
| (rpm) | | | | | | |
| AC | 3.57 | 1 | 3.57 | 978.76 | 0.001 | |
| AE | 0.4584 | 1 | 0.4584 | 125.54 | 0.0079 | |
| Residual | 0.0073 | 2 | 0.0037 | | | |
| Cor Total | 14.22 | 15 | | | | |

Li recovery procedures were similar to Example 1, where NaOH was substituted with one or more mentioned above chemicals. For roasting, representative samples of α-spodumene concentrate prepared as discussed below (α-spodumene concentrate composition comprises 25.1% Al₂O₃, 0.66% CaO, 0.73% Fe₂O₃, 1.06% Na₂O, 65.7% SiO₂, and 5.7% Li₂O) were uniformly mixed with (3 grams of) each of the roasting reagents, then transferred to zirconium crucibles and heated in the conventional oven for 2 hr at the melting point of each chemical (e.g., Na₂CO₃: 851° C., NaCl: 801° C., Na₂SO₄: 885° C., and KOH: 36° C.). However, it is also understood that these temperatures can be reduced if the roasting is performed under elevated pressure or in microwave heating, as discussed above.

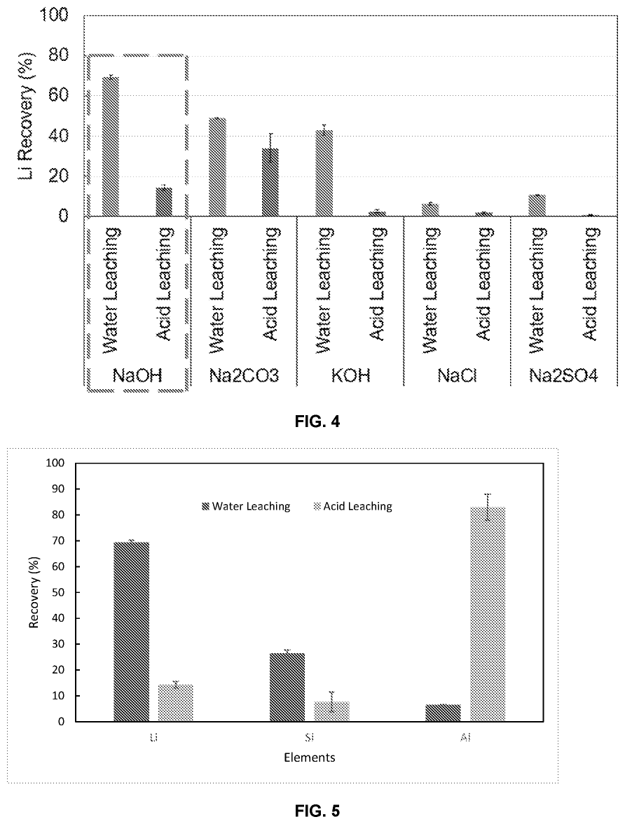

For the most efficient roasting chemicals, the experiments were repeated at least three times for statistical analysis. The results are shown in FIG. 4. It can be seen that NaOH shows the most efficient Li recovery yield.

### Example 3

A microwave roasting of spodumene with NaOH was further explored to minimize the required energy for roasting.

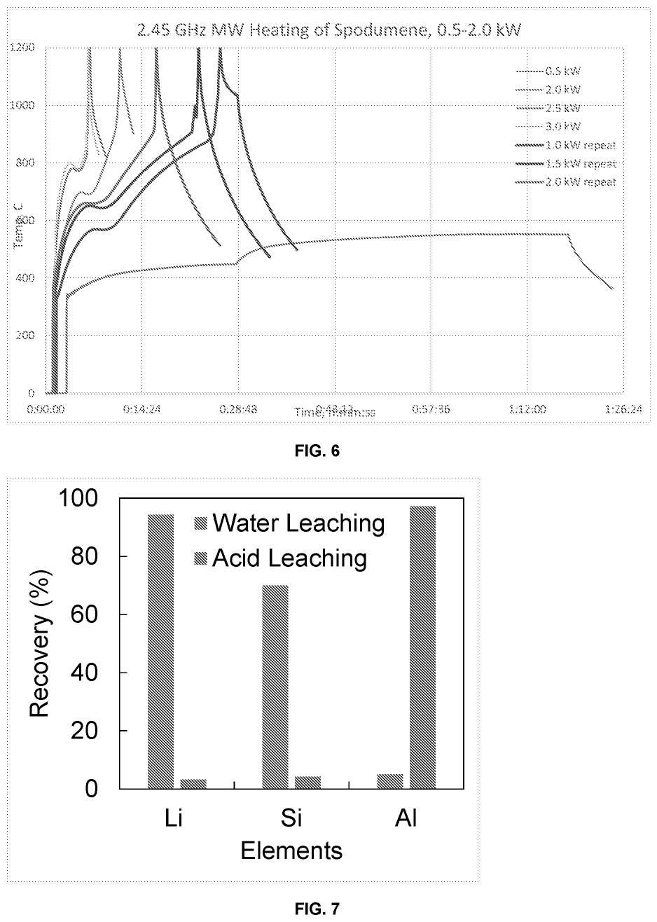

First, microwaves' heating efficiency was tested on a spodumene sample that did not contain any roasting agents (for example, NaOH). It was found that there a critical temperature, after which spodumene adsorb microwaves (above 800° C.). The results are shown in FIG. 6. However, it was also found that when the spodumene is mixed with NaOH, the temperature quickly increases since the NaOH is a bipolar material and very quickly adsorbs MW, melts, and reacts with spodumene.

The Li recovery was conducted using a 2.45 GHz, 6 kW multimode batch system operating at 1.5 kW at 400° C. The α-spodumene to NaOH ratio was 1:1, and the roasting time was 5 minutes. The results of such treatment are shown in FIG. 7. It can be seen that more than 90% recovery of Li after the water leaching can be obtained when the samples are roasted with a microwave source.

Compared to conventional heating, cost-saving, low processing time, direct, non-contact, selective, internal and volumetric heating, and a more controllable heating process are tangible benefits of the proposed microwave processing. As a result of the microwave internal heating characteristics and increased host mineral porosity, the required temperature of the chemical reaction and sintering time are significantly lower and shorter than those of conventional roasting.

### Example 4

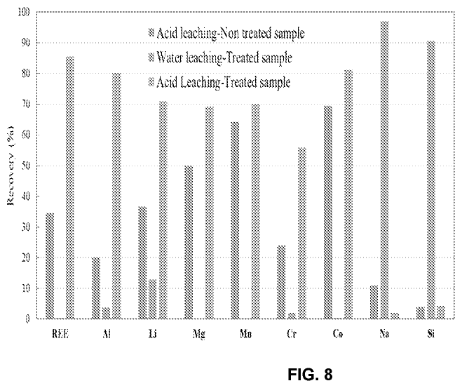

The coal overburden or a clay-enriched shale was tested for various elemental recovery. The experiments were conducted similarly to Example 3 using a 2.45 GHz, 6 kW multimode batch microwave system operating at 1.5 kW at 400° C. The results are shown in FIG. 8. As it can be seen, the water leaching of Li from the clay material is less efficient than the water leaching of Li from α-spodumene source.

However, the overall recovery after water and acid leaching was significantly increased (compared to the values of the non-roasted samples leached with strong acid). This result shows the high efficiency of the process (i.e., sequential chemical roasting (for phase transformation of the aluminosilicate to water and acid soluble phases), water leaching (to remove unreacted chemicals, recover waster soluble phases, reduce the amount of materials fed to acid circuitry, and reduce acid consumption), and acid leaching (to recover generated acid-soluble phases)) in the recovery of Li from the clay sources.

The claims are not intended to include, and should not be interpreted to include, means-plus- or step-plus-function limitations, unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

### Aspects

Aspect 1: A method comprising: a) heating a mixture of a lithium-bearing material provided in a water-insoluble solid form and a solid roasting agent for a first predetermined time to form a solid composition comprising at least one water-soluble phase and at least one water-insoluble phase, wherein the at least one water-soluble phase comprises a first amount of lithium and wherein the at least one water-insoluble phase comprises a second amount of lithium; wherein the heating is at a heating temperature from about 100° C. to less than about 850° C.; b) suspending the solid composition in a first aliquot of water for a second predetermined time, thereby dissolving the at least one water-soluble phase and forming a first suspension comprising a first solid phase and a first liquid phase, wherein the first liquid phase comprises a first portion of the first amount of lithium and wherein the first solid phase comprises the at least one water-insoluble phase comprising the second amount of lithium; c) recovering the first portion of the first amount of lithium from the first liquid phase; and d) optionally: i) suspending the first solid phase in a second aliquot of water for a third predetermined time to form a further suspension comprising a further solid phase and a further liquid phase; ii) recovering a further portion of the first amount of lithium from the further liquid phase; and iii) if the further liquid phase is not substantially free of the further portion of the first amount of lithium in the further liquid phase subjecting the further solid phase to steps i)-ii).

Aspect 2: The method of Aspect 1, wherein step d) is present.

Aspect 3: The method of any one of Aspects 1-2, wherein any of the steps a)-d) is performed under a pressure from about 0.1 MPa to about 20 MPa.

Aspect 4: The of any one of Aspects 1-3, wherein if the further liquid phase is substantially free of the further portion of the first amount of lithium recycling the further liquid phase to the first aliquot of water.

Aspect 5: The method of any one of Aspects 1-4, wherein the roasting agent comprises one or more compounds comprising one or more of alkali, alkaline-earth metals, or ammonium-based compounds, or a combination thereof.

Aspect 6: The method of Aspect 5, wherein the one or more compounds comprise NaOH, Na₂CO₃, KOH, K₂CO₃, MgCO₃, CaCO₃, BaCO₃, NaCl, KCl, CaCl₂, MgCl₂, NaNO₃, LiNO₃, KNOB, Ca(NO₃)₂, Ba(NO₃)₂, Mg(NO₃)₂, Ca(OH)₂, CaSO₄, (NH₄)₂SO₄, Na₂SO₄, or any combination thereof.

Aspect 7: The method of Aspect 5 or 6, wherein the one or more compounds comprise at least an amount of NaOH.

Aspect 8: The method of any one of Aspects 1-7, wherein the lithium-bearing material comprises a-spodumene, lepidolite, hectorite, jadarite, Li-enriched clays, waste streams of mining and processing of coal and coal by-products and minerals and oil shale, Li-batteries, recycled materials, or any combination thereof.

Aspect 9: The method of any one of Aspects 1-8, wherein the lithium-bearing material further comprises one or more of aluminum, calcium, iron, silicon, sodium, or at least one of rare earth elements.

Aspect 10: The method of Aspect 9, wherein the first liquid phase further comprises a first amount of one or more of aluminum, calcium, iron, silicon, sodium, or at least one of rare earth elements.

Aspect 11: The method of any one of Aspects 1-10, wherein the mixture comprises a ratio of the roasting agent to the lithium-bearing material between about 0.1:1 to about 10:1, wherein the ratio is calculated by the weight of the roasting agent to the weight of the lithium-bearing material.

Aspect 12: The method of any one of Aspects 1-11, wherein the heating comprises a heated chamber comprising one or more heating sources effective to provide the heating temperature.

Aspect 13: The method of Aspect 12, wherein the one or more heating sources comprise a microwave heating source.

Aspect 14: The method of Aspect 13, wherein the microwave source has a frequency between about 900 MHz to about 6 GHz.

Aspect 15: The method of Aspect 13 or 14, wherein the microwave source has an energy between about 500 W to about 30 kW.

Aspect 16: The method of any one of Aspects 1-15, wherein the first predetermined time is from about 0.5 seconds to about 24 hours.

Aspect 17: The method of any one of Aspects 1-16, wherein the second predetermined time and/or the third predetermined time is from about 1 min to about 72 hours.

Aspect 18: The method of any one of Aspects 1-17, wherein the suspending comprises heating of the first suspension and/or the further suspension if present.

Aspect 19: The method of Aspect 18, wherein the heating of the first suspension or the further suspension, if present, occurs is at a temperature from about 20° C. to about 100° C.

Aspect 20: The method of any one of Aspects 1-19, wherein the suspending comprises mixing the first suspension or the further suspension if present.

Aspect 21: The method of any one of Aspects 1-20, wherein the first portion of the first amount of lithium is at least 5% of all lithium present in the lithium-bearing material.

Aspect 22: The method of any one of Aspects 1-21, wherein the first portion of the first amount of lithium is from about 5% to less than 100% of all lithium present in the lithium-bearing material.

Aspect 23: The method of any one of Aspects 1-22, wherein a sum of the first portion and the further portion of the first amount of lithium is from about 5% to less than 100% of all lithium present in the lithium-bearing material.

Aspect 24: The method of any one of Aspects 1-23, further comprising collecting the first solid phase or the further solid phase if present.

Aspect 25: The method of Aspect 24, further comprising a) adding a first aliquot of an acid to the first solid phase or the further solid phase if present; and b) suspending the first solid phase or the further solid phase if present in the amount of acid for a fourth predetermined time to form an additional suspension comprising an additional solid phase and an additional liquid phase, wherein the additional liquid phase comprises a first portion of the second amount of lithium and wherein the additional solid phase comprises a second portion of the second amount of lithium.

Aspect 26: The method of Aspect 25 further comprising recovering the first portion of the second amount of lithium from the additional liquid phase.

Aspect 27: The method of Aspect 25 or 26, wherein the fourth predetermined time is from about 1 min to about 72 hours.

Aspect 28: The method of any one of Aspects 25-27, wherein b) further comprises mixing the additional suspension.

Aspect 29: The method of any one of Aspects 25-28, wherein b) further comprises keeping the additional suspension at a temperature from about 20° C. to about 300° C.

Aspect 30: The method of any one of Aspects 25-29, wherein the additional liquid phase comprises a second amount of one or more of aluminum, calcium, iron, silicon, sodium, or at least one of rare earth elements.

Aspect 31: The method of Aspect 30 further comprising recovering the second amount of one or more of aluminum, calcium, iron, silicon, sodium, or at least one of rare earth elements.

Aspect 32: The method of any one of Aspects 25-31, comprising collecting the additional solid phase.

Aspect 33: The method of Aspect 33 further comprising the sequence of steps: i) step of adding a second aliquot of an acid to the additional solid phase to form a further additional suspension comprising a further additional solid phase and a further additional liquid phase, wherein the further additional liquid phase optionally comprises a further portion of the second amount of lithium; ii) separating the further additional liquid phase and further additional solid phase; if the further additional liquid phase comprises the further portion of the second amount of lithium, the further additional solid phase is further subjected to the steps i)-ii); if the further additional liquid phase is substantially free of the further portion of the second amount of lithium, recycling the further additional liquid phase to the first or the second aliquot of the acid.

Aspect 34: The method of Aspect 33 further comprising combining the additional liquid phase and each of the further additional liquid phases.

Aspect 35: The method of Aspect 34, recovering all portions of the second amount of lithium.

Aspect 36: The method of any one of Aspects 25-35, wherein the acid comprises H₂SO₄, HCl, H₃PO₄, HNO₃ or any combination thereof.

Aspect 37: The method of any one of Aspects 25-36, wherein any of the steps a)-b) and/or i)-ii) is performed under a pressure from about 0.1 MPa to about 20 MPa.

1. A method comprising:
a) heating a mixture of a lithium-bearing material provided in a water-insoluble solid form and a solid roasting agent for a first predetermined time to form a solid composition comprising at least one water-soluble phase and at least one water-insoluble phase, wherein the at least one water-soluble phase comprises a first amount of lithium and wherein the at least one water-insoluble phase comprises a second amount of lithium; wherein the heating is at a heating temperature from about 100° C. to less than about 850° C.;
b) suspending the solid composition in a first aliquot of water for a second predetermined time, thereby dissolving the at least one water-soluble phase and forming a first suspension comprising a first solid phase and a first liquid phase, wherein the first liquid phase comprises a first portion of the first amount of lithium and wherein the first solid phase comprises the at least one water-insoluble phase comprising the second amount of lithium;
c) recovering the first portion of the first amount of lithium from the first liquid phase; and
d) optionally:
i) suspending the first solid phase in a second aliquot of water for a third predetermined time to form a further suspension comprising a further solid phase and a further liquid phase;
ii) recovering a further portion of the first amount of lithium from the further liquid phase; and
iii) if the further liquid phase is not substantially free of the further portion of the first amount of lithium in the further liquid phase subjecting the further solid phase to steps i)-ii).

2. The method of claim 1, wherein step d) is present.

3. The method of claim 1, wherein any of the steps a)-d) is performed under a pressure from about 0.1 MPa to about 20 MPa.

4. The method of claim 1, wherein if the further liquid phase is substantially free of the further portion of the first amount of lithium, the method further comprises a step of recycling the further liquid phase to the first aliquot of water.

5. The method of claim 1, wherein the roasting agent comprises one or more compounds comprising one or more of alkali, alkaline-earth metals, or ammonium-based compounds, or a combination thereof.

6. (canceled)

7. The method of claim 5, wherein the one or more compounds comprise at least an amount of NaOH.

8. The method of claim 1, wherein the lithium-bearing material comprises α-spodumene, lepidolite, hectorite, jadarite, Li-enriched clays, Li-batteries, waste streams of mining and processing of coal and coal by-products and minerals and oil shale, coal underclay, coal overburden, recycled materials, or any combination thereof, and/or wherein the lithium-bearing material further comprises one or more of aluminum, calcium, iron, silicon, sodium, or at least one of rare earth elements.

9. (canceled)

10. The method of claim 8, wherein the first liquid phase further comprises a first amount of one or more of aluminum, calcium, iron, silicon, sodium, or at least one of rare earth elements.

11. The method of claim 1, wherein the mixture comprises a ratio of the roasting agent to the lithium-bearing material between about 0.1:1 to about 10:1, wherein the ratio is calculated by the weight of the roasting agent to the weight of the lithium-bearing material.

12. The method of claim 1, wherein the heating comprises a heated chamber comprising one or more heating sources effective to provide the heating temperature, and wherein the one or more heating sources comprise a microwave heating source.

13. (canceled)

14. The method of claim 12, wherein the microwave source has a frequency between about 900 MHz to about 6 GHz, and wherein the microwave source has an energy between about 500 W to about 30 kW.

15. (canceled)

16. The method of claim 1, wherein the first predetermined time is from about 0.5 seconds to about 24 hours; and/or wherein the second predetermined time and/or the third predetermined time is from about 1 min to about 72 hours.

17. (canceled)

18. The method of claim 1, wherein the suspending comprises heating of the first suspension and/or the further suspension if present.

19. The method of claim 18, wherein the heating of the first suspension or the further suspension, if present, occurs is at a temperature from about 20° C. to about 100° C.

20. (canceled)

21. (canceled)

22. The method of claim 1, wherein the first portion of the first amount of lithium is from about 5% to less than 100% of all lithium present in the lithium-bearing material.

23. The method of claim 1, wherein a sum of the first portion and the further portion of the first amount of lithium is from about 5% to less than 100% of all lithium present in the lithium-bearing material.

24. (canceled)

25. The method of claim 1, further comprising collecting the first solid phase or the further solid phase if present and then
a) adding a first aliquot of an acid to the first solid phase or the further solid phase if present; and
b) suspending the first solid phase or the further solid phase if present in the amount of acid for a fourth predetermined time to form an additional suspension comprising an additional solid phase and an additional liquid phase, wherein the additional liquid phase comprises a first portion of the second amount of lithium and wherein the additional solid phase comprises a second portion of the second amount of lithium.

26. The method of claim 25 further comprising recovering the first portion of the second amount of lithium from the additional liquid phase.

27. The method of claim 25, wherein the fourth predetermined time is from about 1 min to about 72 hours.

28. The method of claim 25, wherein b) further comprises mixing the additional suspension and/or wherein b) further comprises keeping the additional suspension at a temperature from about 20° C. to about 300° C.

29. (canceled)

30. The method of claim 25, wherein the additional liquid phase comprises a second amount of one or more of aluminum, calcium, iron, silicon, sodium, or at least one of rare earth elements.

31. The method of claim 30 further comprising recovering the second amount of one or more of aluminum, calcium, iron, silicon, sodium, or at least one of rare earth elements.

32. The method of claim 25, comprising collecting the additional solid phase, wherein the step of collecting comprises the sequence of steps:
i) step of adding a second aliquot of an acid to the additional solid phase to form a further additional suspension comprising a further additional solid phase and a further additional liquid phase, wherein the further additional liquid phase optionally comprises a further portion of the second amount of lithium;
ii) separating the further additional liquid phase and further additional solid phase;
if the further additional liquid phase comprises the further portion of the second amount of lithium, the further additional solid phase is further subjected to the steps i)-ii); and
if the further additional liquid phase is substantially free of the further portion of the second amount of lithium, recycling the further additional liquid phase to the first or the second aliquot of the acid.

33. (canceled)

34. The method of claim 32 further comprising combining the additional liquid phase and each of the further additional liquid phases, and then recovering all portions of the second amount of lithium.

35. (canceled)

36. The method of claim 25, wherein the acid comprises H₂SO₄, HCl, H₃PO₄, HNO₃ or any combination thereof

37. The method of claim 25, wherein any of the steps a)-b) and/or i)-ii) is performed under a pressure from about 0.1 MPa to about 20 MPa.
